(19) United States
(12) Patent Application Publication
(10) Pub. No.: US 2001/0035720 A1
(43) Pub. Date: Nov. 1, 2001

(54) High intensity light source

(76) Inventors: Charles Guthrie, San Jose, CA (US); Edmund Sandberg, Monte Sereno, CA (US); Donald Wilson, San Jose, CA (US); Gregory Prior, San Jose, CA (US)

Correspondence Address: GARY CARY WARE & FREIDENRICH LLP, 1755 EMBARCADERO RD, PALO ALTO, CA, 94303-3340, US

(21) Appl. No.: 09/818,092

(22) Filed: Mar. 26, 2001

Related U.S. Application Data
(60) Provisional application No. 60/192,731, filed on Mar. 27, 2000.
(60) Provisional application No. 60/224,059, filed on Aug. 9, 2000.
(60) Provisional application No. 60/224,298, filed on Aug. 10, 2000.
(60) Provisional application No. 60/224,290, filed on Aug. 10, 2000.
(60) Provisional application No. 60/224,291, filed on Aug. 10, 2000.
(60) Provisional application No. 60/224,257, filed on Aug. 10, 2000.
(60) Provisional application No. 60/224,289, filed on Aug. 10, 2000.
(60) Provisional application No. 60/224,866, filed on Aug. 11, 2000.
(60) Provisional application No. 60/234,415, filed on Sep. 21, 2000.

(51) Int. Cl. H01J 65/04

(52) U.S. Cl. 315/39; 315/248

(57) ABSTRACT

In one aspect the plasma lamp according to the present invention comprises a gas envelope that is constructed from ceramic material and a sapphire window rather than quartz. According to another aspect of the present invention, a plasma lamp comprises an RF structure for the radio wave radiation and an envelope for housing the excitation gas that are formed so as to constitute a single, integrated ceramic structure. According to yet another aspect of the present invention, the plasma lamp comprises a waveguide structure having solid material such as ceramic rather than air for the dielectric and a gas housing made of a combination of solid ceramic and a sapphire window. In this way, the separate quartz gas envelope and air-filled waveguide structure employed in the prior art are replaced by a single, integrated structure.

This application claims the benefit of the following U.S. Provisional Applications: U.S. Provisional Application Nos. 60/192,731 filed Mar. 27, 2000; 60/224,059 filed Aug. 9, 2000; 60/224,298 filed Aug. 10, 2000; 60/224,290 filed Aug. 10, 2000; 60/224,291 filed Aug. 10, 2000; 60/224,257 filed Aug. 10, 2000; 60/224,289 filed Aug. 10, 2000; 60/224,866 filed Aug. 11, 2000; and 60/234,415 filed Sep. 21, 2000. All of these provisional applications are hereby incorporated by reference in their entireties.

### FIELD OF THE INVENTION

The present invention is directed generally to high intensity light sources and more particularly to plasma light sources for use in applications such as projection systems based on reflective microdisplays.

### BACKGROUND OF THE INVENTION

There is a continuing need for long-lived, efficient, compact, and high intensity white light sources for applications such as projection-based televisions and computer monitors as well as movie screen projectors. The various kinds of light sources which have been used previously include arc lamps and plasma lamps. Although an arc lamp produces an intense light by maintaining an electric arc between two electrodes, arc lamps have not tended to be long-lived for at least two reasons. First, the electrodes between which the arc is formed inevitably deteriorate and erode during the operation of the arc lamp, and ultimately this erosion leads to lamp failure. Second, arc lamps conventionally employ an envelope or bulb made from a transparent material in order to contain the gas fill of the lamp. Quartz has conventionally been used for such bulbs or gas envelopes.

Quartz bulbs, however, have several disadvantages. Because quartz devitrifies or recrystalizes at elevated temperatures, quartz bulbs do not endure well the high temperatures and repeated heatings inherent in lamp operation, and they tend to eventually discolor or crack causing lamp failure and limiting the useful life span of the lamp. In addition, because quartz has a low thermal conductivity, the use of the quartz bulb limits the maximum operating temperature of the lamp, and, therefore, the maximum obtainable brightness. Furthermore, quartz is partially permeable so that gas tends to slowly diffuse out of the bulb envelope. Ultimately, this diffusion causes the lamp to fail.

Unlike arc lamps, plasma lamps do not rely on electrodes, but rather produce light by creating a plasma discharge in a gas contained in a bulb by exposing the lamp gas to intense radio wave or radio frequency radiation. (As used herein, the phrase “radio wave radiation”, as well as the acronym “RF”, is intended to encompass electromagnetic radiation frequencies in either the conventional radio frequency range or in the conventional microwave frequency range.) Although there are no electrodes to fail in the case of a plasma lamp, the transparent bulb that is conventionally used to contain the gas is also typically made of quartz and has the same disadvantages discussed above in connection with the arc lamp because of the high operating temperatures involved.

In order to mitigate the bulb failure problem, various mechanical cooling arrangements have been developed to rotate the bulb and to propel cooling air onto its outer surface during lamp operation. However, such mechanical arrangements are complex, expensive, and occupy space which is often a scarce resource in the intended application for the lamp. In addition, the presence of these mechanical arrangements compromises the ability to collect the light generated by the lamp, thereby reducing efficiency.

Plasma lamps also conventionally require a separate mechanism to couple the radio wave radiation generated by the radiation source to the bulb filled with the plasma discharge-forming medium. The need for such a separate coupling mechanism is another problem with the plasma lamp because inefficiency of the coupling correspondingly constrains the overall efficiency of the plasma lamp. One conventional approach to such coupling is to mount the bulb near a separate air-filled RF structure, such as a waveguide, that receives the radio wave radiation from the radiation source and transmits the radiation to the bulb. In practice this approach may lead to a power loss as high as 60% because of coupling inefficiencies. In addition, the resulting structure is not physically compact because the RF structure is separate from the bulb.

Alternatively, it is known to mount the quartz bulb inside a separate structure and to place coils near to the bulb in order to inductively transfer radio wave radiation energy to the gas in the bulb. Again, however, the resulting structure lacks integration and compactness because the RF structure is separate from the bulb.

It is desirable to provide improved light sources that avoid these and other problems with known light sources, and it is to these ends that the present invention is directed.

### SUMMARY OF THE INVENTION

According to one aspect of the invention, a plasma lamp is provided that comprises a gas housing containing a plasma discharge forming medium, and a source of radio frequency energy coupled to the plasma discharge medium. The gas housing is constructed from ceramic material and has a window transparent to visible light.

In more specific aspects, the window may be a sapphire window. The invention greatly extends the operating life expectancy of the plasma lamp as compared with the prior art lamps which use quartz because the problems of quartz devitrification at high temperature and quartz gas permeability are eliminated.

According to another aspect of the present invention, the RF structure used for the radio wave radiation and the envelope used to house the gas fill are formed so as to constitute a single, integrated ceramic structure.

According to another aspect of the present invention, solid material such as ceramic rather than air is used for the dielectric and the gas fill is contained by a combination of solid ceramic and a sapphire window. In this way the separate gas envelope and air-filled waveguide structure employed in the prior art are replaced by a single, integrated structure.

Because the integration of the RF structure and the gas envelope permits the quartz bulb to be done away with entirely, plasma lamps according to the present invention enjoy an unprecedented operating life expectancy as compared with the prior art. This is so in part because the problems associated with the inability of the quartz bulb to withstand heatings are eliminated.

In addition, the integrated design of the present invention enables a much higher proportion of the radio wave radiation energy to be focused onto the gas fill. As a result, the plasma lamp according to the present invention is made much more efficient.

The present invention enables these and many other benefits to be obtained.

### BRIEF DESCRIPTION OF THE FIGURES

FIG. 1 is a side cross-sectional view of a gas housing for a plasma lamp according to a first embodiment of the invention.

FIG. 2 is a side cross-sectional view of a plasma lamp according to a second embodiment of the invention.

FIG. 3 is a side cross-sectional view of a plasma lamp according to a third embodiment of the invention in which the gas housing is integral with a waveguide comprising a solid dielectric material.

FIG. 4A is an end view of a plasma lamp according to a fourth embodiment of the invention in which the gas housing is integral with a waveguide comprising a solid dielectric material while FIG. 4B is a side cross-sectional view of the same plasma lamp.

FIG. 5 is a side cross-sectional view of a plasma lamp according to a fifth embodiment of the invention in which the gas housing is also integral with a waveguide comprising a solid dielectric material.

FIG. 6 shows a process suitable for sealing a gas housing according to the present invention.

FIG. 7 is a side cross-sectional view of an alternative embodiment of the plasma lamp of FIG. 2.

### DETAILED DESCRIPTION OF PREFERRED EMBODIMENTS

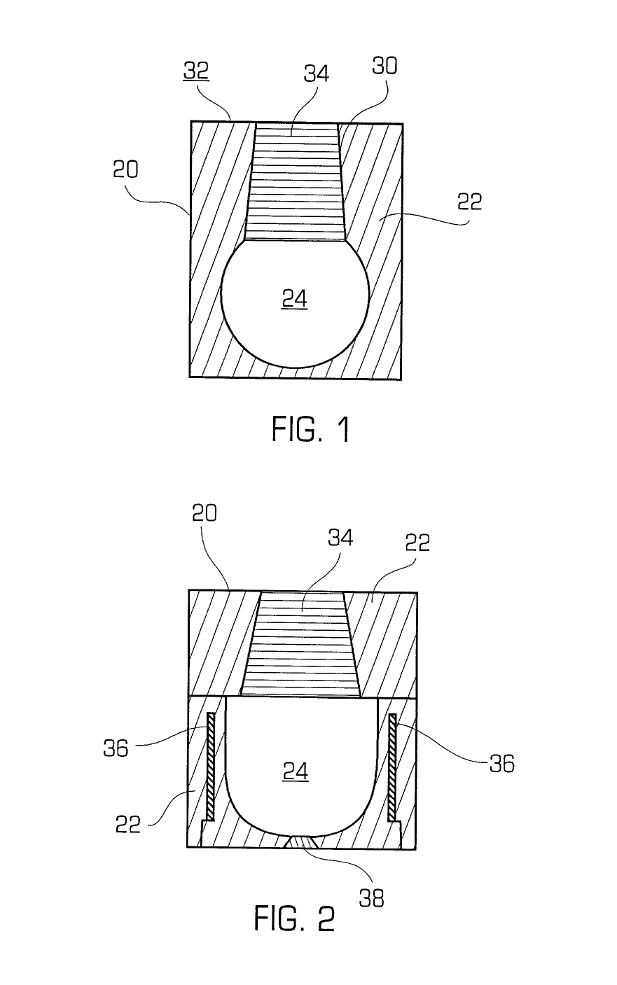

FIG. 1 shows a first embodiment of an improved light source in accordance with the invention. The light source may be a plasma lamp comprising a gas housing 20 preferably formed from a ceramic material 22, as will be described below, with an interior cavity or chamber 24 for containing gas. The housing may generally be rectilinear or cubic, and the chamber may be spherical. A channel 30 may connect the chamber to an exterior surface 32 of the housing. The channel 30 may be made of light transmissive material, preferably of sapphire in order to form a window 34 for emitting visible light from the chamber. The window preferably has a generally tapered, conical shape; i.e., a frusto-conical shape. The sapphire window seals the chamber to contain the gas, while affording an exit for the light produced by the plasma discharge.

Sapphire is preferred for the window since it is less gas permeable than quartz, for example, and better withstands the heat cyclings and high temperatures associated with lamp operation. Furthermore, the gas housing 20 is preferably made from a ceramic material, as described below, since ceramics are much more durable under heating than other materials such as quartz. As a result, the ceramic housing affords a much longer life expectancy for the plasma lamp than the conventional quartz bulb of the prior art. In addition, the ceramic housing advantageously enables the plasma lamp to be operated at a much higher maximum temperature than the quartz bulb, because it avoids the lower softening temperature point and low thermal conductivity limitations of quartz.

The sapphire window 34 may function as a “light integrator” for transmitting the light of the plasma lamp from the chamber, for example, to application-specific optics. The tapered, conical sapphire window 34 may be sealed against the surrounding ceramic material forming the channel 30 by coating the outside edges of the sapphire window with a material such as a glass containing MgO, or, alternatively, with SiO₃ or SiO₂. Next the mating surfaces of both the window and the ceramic channel may each be coated with a thin layer of metallic material, such as copper, a copper alloy, or platinum. Then a piece of preferably pure platinum wire may be placed between the two thin film layers. Finally, a laser is used to heat the wire, and thereby melt the metallic material and bond the layers together.

Alternatively, the coated sapphire window 34 may be sealed to the ceramic housing by heating a glass frit. In yet another alternative, the ceramic housing may be “shrunk down” onto the sapphire window during high temperature firing.

The gas fill in the plasma lamp according to the first embodiment of the invention can be coupled to a source of electromagnetic energy, such as radio wave radiation in any of a variety of ways in order to create a plasma discharge within chamber 24. Preferably this should be done so that the RF structure that is active with the radio wave radiation energy is integrated with the gas housing 20, as will be described.

The gas fill may appropriately be a combination of a metal compound and a carrier gas. The metal compound may preferably be a metal halide such as indium bromide. Other examples of suitable metal compounds are praseodymium and mercury. Preferred gases for the carrier gas are xenon, neon, argon, or krypton.

FIG. 2 shows a second embodiment of a lamp in accordance with the invention which is somewhat similar to FIG. 1 except that the gas housing has an integrated RF energy structure. In FIG. 2, the elements are designated similarly to FIG. 1, using like reference numerals for like elements. The gas fill chamber 24 may be housed in a gas housing 20 preferably comprising a ceramic material 22 and provided with a light transmissive window 34, preferably of a tapered rod of sapphire and a fill plug 38 as previously described. In this embodiment, an RF energy structure such as one or more coils 36 may be formed within the ceramic housing. The coils 36 function to inductively couple radio wave radiation energy to the gas fill in chamber 24 in order to create the plasma discharge. In this way, the RF structure of the plasma lamp that is active with radio wave energy is integral with the ceramic housing 20 that contains the plasma gas fill. This integration of the RF structure of the plasma lamp and the gas housing into a single structure, as shown, improves the coupling of RF energy to the gas, and allows significant gains in lamp efficiency and compactness.

The second embodiment may also comprise segments of ferrite material 41 placed adjacent the coils 36 in order to help concentrate the magnetic field associated with the coils 36 on the gas fill. An illustration of this embodiment is shown in FIG. 7.

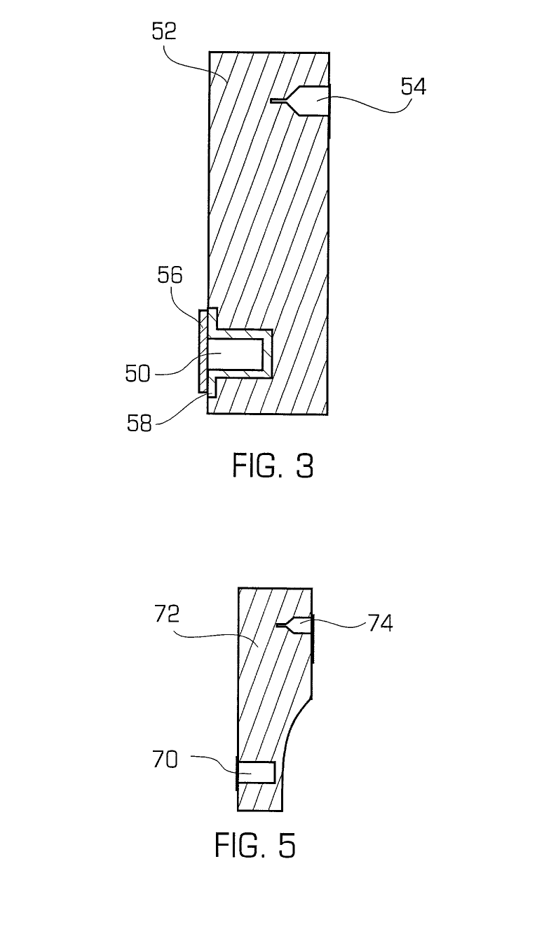

FIG. 3 shows a third embodiment of a lamp in accordance with the invention which integrates both the gas housing and an RF energy source within the same structure. A gas housing 50 for the gas fill may be formed so as to be integral with a waveguide 52 which preferably comprises a ceramic structure having a substantially rectangular cross-section. Because no separate bulb is used, the housing 50 and waveguide 52 comprise a single, integrated structure. A source of radio wave radiation 54 may be disposed within the ceramic structure, for example, near one end of the waveguide. The RF source 54 may be an RF antenna, a probe, or the like for introducing RF energy into the waveguide. The gas housing 50 may be located near the other end of the waveguide, for example. As shown, the gas housing may further include a light transmissive window 56 connected to the end wall of the housing. The window is preferably made from sapphire.

The dimensions of the waveguide and the locations of the RF source and gas housing preferably are chosen so that the electromagnetic field produced by the radio wave radiation in the waveguide exhibits a maximum in intensity at or near to the location of the housing in order to optimize the energy coupling to the gas. The waveguide may form a resonant structure having a resonant mode at the frequency of the radiation from the RF source 54. The necessary relationship among the waveguide dimensions, dielectric constant, and RF frequency can be determined in a well-known way using electromagnetic waveguide theory. For example, it is well-known that for a rectangular waveguide cavity containing a dielectric with permeability and permittivity constants μ and ∈, and having length, width and depth dimensions a, b, and d and metal boundaries, the frequencies w(m,n,p) for the resonant modes are given by the following equation:

w(m,n,p)=(μ∈)^{-1,2}(m²π²/a²+n²π²/b²+p²π²/d²)^{½}

where m, n, and p are integers.

Furthermore, because the dimensions of the waveguide scale with the square root of the dielectric constant of the dielectric, use of a solid dielectric material instead of an air dielectric permits a dramatic reduction in waveguide size, particularly if a ceramic material with an appropriately high dielectric constant is chosen. The waveguide is preferably made from a solid ceramic material with a high dielectric constant (higher than air or greater than 1), such as titanium dioxide (TiO₂) or barium neodymium titinate. In practice, it is found that materials that exhibit a suitably high dielectric constant are typically porous and unable to provide the required hermicity to contain the gas fill. Accordingly, as shown in FIG. 3, a liner 58 of a better hermetic ceramic, such as alumina (Al₂O₃), is preferably deposited along the inner boundary of the ceramic material that forms the gas housing. This liner 58 improves the sealing of the gas fill.

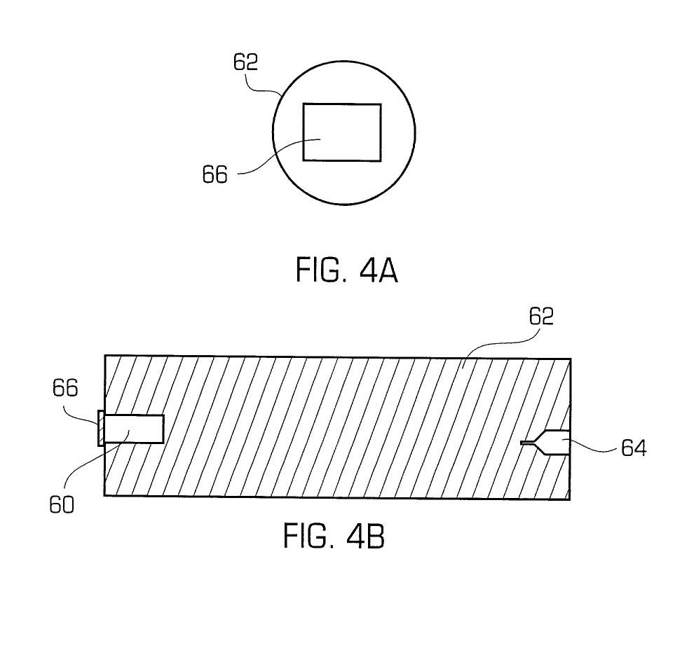

FIGS. 4A and 4B show a fourth embodiment of a light source in accordance with the invention. A gas housing 60 for the gas fill is formed so as to be integral with a cylindrical resonant waveguide structure 62 comprising ceramic material. Because a separate bulb is not used, the gas housing 60 and waveguide 62 comprise a single, integrated structure. A source of radio wave radiation 64 may be disposed near one end of the waveguide, while the gas housing is formed at an opposite end. The gas housing 60 may include a window 66 preferably made from sapphire.

As with the embodiment of FIG. 3, the dimensions of the waveguide structure, the locations of the RF source and gas housing, and the frequency of the radio wave radiation source may be chosen so as to support resonant modes which optimize the RF energy coupling from the RF source to the gas housing. The gas housing 60 may, therefore, be appropriately located so that the housing receives a high level of radio wave radiation energy from the source 64.

FIG. 5 shows a fifth embodiment of the present invention. In this case the waveguide 72 may have a cross-section with a varying dimension, such as a varying profile rather than a rectangular cross-section in order to improve the matching of the impedance of the waveguide to that of a gas housing 70 in the waveguide. In turn, this improved impedance matching broadens somewhat the range of frequencies over which the waveguide forms a resonant structure so as to efficiently deliver power to the gas housing. As with the first embodiment, however, a separate bulb is not used so that the gas housing 70, waveguide 72, and radio wave radiation source 74 comprise a single, integrated structure. The dimensions of the waveguide and the locations of the radio wave radiation source and housing, may appropriately be chosen to produce a resonant mode that maximizes the energy coupled from the source to the gas housing for the operating frequency band of the source.

In other embodiments of the invention, the interior of the gas housing may be coated with a thin film of protective material such as MgO. The MgO will protect the inner surface of the gas housing from the spontaneous conversion of ceramic to elemental metal that sometimes occurs in the presence of a partial vacuum and high temperature. This effect is not desirable and may cause failure of the bulb. Because the film of MgO acts as a secondary electron emitter, the film can also add to the brightness of the plasma lamp.

In alternative embodiments of the invention, a bulb made from quartz or another suitable material may be retained as a structure which houses the gas fill, but the quartz structure is sized so as to fill the interior space in the ceramic gas housing, which ceramic gas housing may be integrated into a ceramic waveguide as described above. This variation can be utilized in conjunction with any of the embodiments of the invention shown in FIGS. 1-5 by expanding the bulb into the interior of the ceramic gas housing with a heating process. One possible heating process is to electrically overdrive the bulb. Alternatively, the outer surface of the quartz bulb may be ground so as to fit closely into the ceramic gas housing or integrated ceramic gas housing and waveguide structure.

An example of a waveguide structure according to these alternative embodiments is a rectangular waveguide structure having dimensions of 34.72 mm by 38.84 mm by 17.37 mm and composed of alumina (Al₂O₃) ceramic. For such a waveguide, the RF structure, e.g., antenna, may appropriately be driven at a frequency of 2.4 gigahertz (GHz) in order to efficiently couple radio wave radiation of that frequency to the gas fill in the quartz bulb within the waveguide.

When the plasma lamp is constructed in such a way, the heat produced by the bulb operated in the normal drive mode will be dissipated more uniformly and rapidly than in the prior art because of the tight fit between the quartz bulb and the surrounding ceramic. In this way the ceramic encasing the quartz bulb acts as a heat sink and ameliorates the problems associated with the heating of a quartz material.

These alternative embodiments having a quartz bulb can be improved by depositing a thin, non-conductive reflective coating on either the inside or outside walls of the quartz bulb. The reflective coating can be deposited by evaporation, spraying, painting or other method and should cover the bulb apart from an “exit” window for the light. The material used may be liquid bright platinum or a similar reflective material. The function of the coating is to improve upon the reflectance of the ceramic and thereby increase the brightness yielded by the lamp.

In other embodiments of the invention, the bulb for containing the gas fill may be made entirely from sapphire rather than quartz. Sapphire is transparent to visible light and can better withstand high temperatures than quartz. Sapphire is also less permeable than quartz. Accordingly, the use of sapphire for the bulb can significantly improve the performance of the plasma lamp as compared with the prior art quartz bulb lamp.

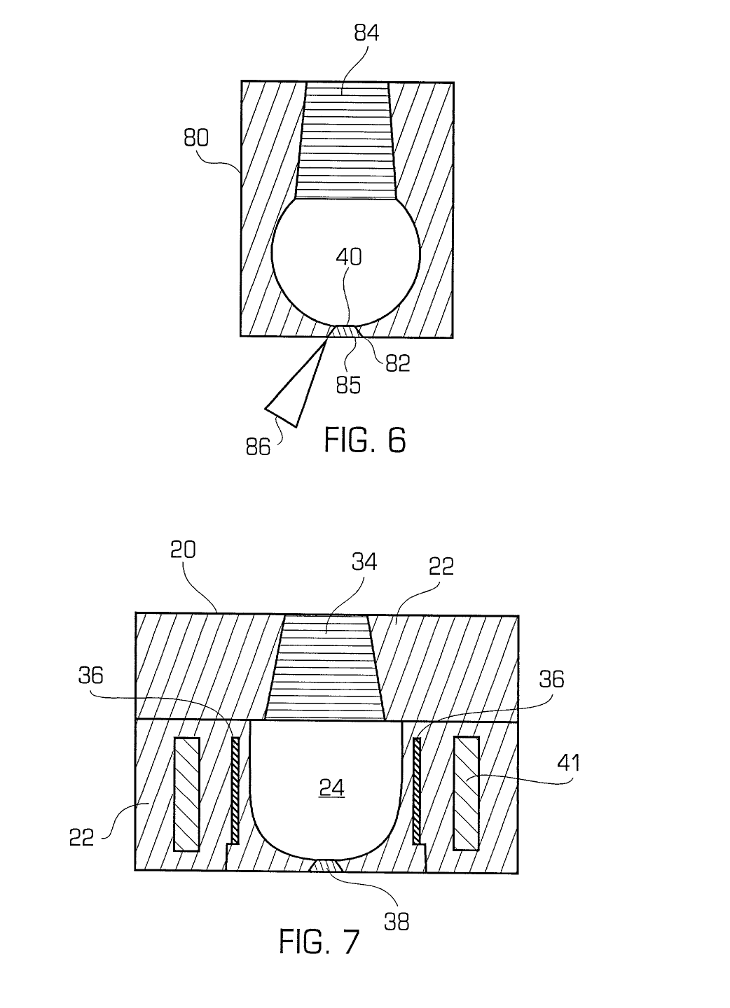

A method for constructing a representative embodiment of the ceramic gas housing for the fill gas of the plasma lamp will now be described with reference to FIG. 6. The first step in this method is to fabricate the housing 80 as by pressing ceramic into a mold. A small fill hole 40 may be left in one end of the housing. A sapphire window 84 is then sealed to the other end of the housing. The ceramic housing may then be placed in a vacuum chamber. An appropriate metal halide material may then be put into the enclosure through the fill hole 40. Next, the vacuum chamber can be pumped down. After the proper subatmospheric pressure is reached, the chamber can then be backfilled with an excitation gas.

The excitation gas is allowed to backfill until the chamber and, hence, the ceramic housing reaches the desired pressure. A ceramic plug 85 may then be used to seal the fill hole in a manner discussed more fully below in connection with FIG. 6. After the fill hole is sealed in such a manner, the lamp is then removed from the vacuum system and tested.

FIG. 6 illustrates an improved sealing procedure that is useful for making plasma lamp gas housings according to the present invention. In particular, it has been found that a tapered fill hole 40 and a matchingly tapered plug 85 provide a stronger seal than a straight-edged fill hole and matching plug. The actual seal between the hole and the plug is made with a glass frit or a ceramic material 82. The seal is formed by suitably heating the fill hole region such as by using laser light 86. The use of laser light is advantageous because it allows the sealing process to be conveniently accomplished while the plasma gas housing is still in the vacuum chamber immediately after the fill material has been added. Furthermore, lasers are especially well suited for this application which requires the quick heating of a small region to a high temperature.

The scope of the present invention is meant to be that set forth in the claims that follow and equivalents thereof, and is not limited to any of the specific embodiments described above.

What is claimed is:

1. A plasma lamp comprising:
a source of radio wave radiation;
a waveguide structure for coupling said radio wave radiation to a plasma discharge-forming medium so as to excite a plasma discharge, said waveguide structure being at least largely composed of solid dielectric material; and
a housing for said plasma discharge-forming medium.

2. A plasma lamp as recited in claim 1, wherein said waveguide structure is a resonant structure which supports at least one resonant mode of said radio wave radiation.

3. A plasma lamp as recited in claim 1, wherein said housing and said waveguide structure form a single, integrated structure.

4. A plasma lamp as recited in claim 3, wherein said housing is formed from ceramic material.

5. A plasma lamp as recited in claim 4, wherein said ceramic material includes alumina.

6. A plasma lamp comprising:
a source of radio wave radiation;
a waveguide structure for coupling said radio wave radiation to a plasma discharge-forming medium so as to excite a plasma discharge said waveguide structure being at least largely composed of a ceramic material; and
a housing for said plasma discharge-forming medium.

7. A plasma lamp as recited in claim 6, wherein said waveguide structure is a resonant structure which supports at least one resonant mode of said radio wave radiation.

8. A plasma lamp as recited in claim 6, wherein said housing and said waveguide structure are integrated into a single structure.

9. A plasma lamp as recited in claim 8, wherein said housing is formed from another ceramic material.

10. A plasma lamp as recited in claim 9, wherein said other ceramic material includes alumina.

11. A plasma lamp as recited in claim 6, wherein said first-mentioned ceramic material includes alumina.

12. A plasma lamp as recited in claim 6, wherein said first-mentioned ceramic material includes titanium dioxide.

13. A plasma lamp as recited in claim 6, wherein said first-mentioned ceramic material includes barium neodymium titinate.

14. A plasma lamp as recited in claim 9, wherein said other ceramic material is the same material as said first-mentioned ceramic material.

15. A plasma lamp comprising:
a source of radio wave radiation;
a waveguide structure for coupling said radio wave radiation to a plasma discharge-forming medium so as to excite a plasma discharge;
a housing for said plasma discharge-forming medium, and
wherein said waveguide structure is at least largely composed of a first ceramic material and said housing is formed from a second ceramic material and includes a window that is transparent to visible light.

16. A plasma lamp as recited in claim 15, wherein said window is formed from sapphire.

17. A plasma lamp as recited in claim 15, wherein said waveguide structure is a resonant structure which supports at least one resonant mode of said radio wave radiation.

18. A plasma lamp as recited in claim 15, where said housing and said waveguide structure are integrated into a single structure.

19. A plasma lamp as recited in claim 15, wherein said second ceramic material includes alumina.

20. A plasma lamp as recited in claim 15, wherein said first ceramic material includes alumina.

21. A plasma lamp as recited in claim 15, wherein said first ceramic material includes titanium dioxide.

22. A plasma lamp as recited in claim 15, wherein said first ceramic material includes barium neodymium titinate.

23. A plasma lamp as recited in claim 15, wherein said second ceramic material is the same as said first ceramic material.

24. A plasma lamp comprising:
a housing containing a plasma discharge-forming medium, said housing being formed of ceramic material and including a window that is transparent to visible light produced by said plasma discharge.
a source of electromagnetic energy; and
means for coupling said electromagnetic energy to the plasma discharge-forming medium so as to excite a plasma discharge.

25. A plasma lamp as recited in claim 24, wherein said window comprises sapphire.

26. A plasma lamp as recited in claim 24, wherein said ceramic material comprises alumina.

27. A plasma lamp as recited in claim 24, wherein the source of electromagnetic energy and the housing are formed within the ceramic material as an integrated structure.

28. A plasma lamp as recited in claim 27, wherein said source of electromagnetic energy comprises electrical coils.

29. A plasma lamp as recited in claim 27, wherein said source of electromagnetic energy comprises an antenna.
